(19) United States
(12) Patent Application Publication
(10) Pub. No.: US 2007/0044881 A1
(43) Pub. Date: Mar. 1, 2007

(54) Dynamic tire-pressure control system

(75) Inventor: Gerhard Skoff, Vienna (AT)

Correspondence Address: THE FIRM OF KARL F ROSS, 5676 RIVERDALE AVENUE, PO BOX 900, RIVERDALE (BRONX), NY, 10471-0900, US

(73) Assignee: STEYR-DAIMLER-PUCH SPEZIALFAHRZEUG GmbH

(21) Appl. No.: 11/510,289

(22) Filed: Aug. 25, 2006

(30) Foreign Application Priority Data
Aug. 25, 2005 (AT) A1396/2005

(51) Int. Cl. B60C 23/10

(52) U.S. Cl. 152/416

(57) ABSTRACT

A dynamic vehicular system for controlling pressure in tires of a vehicle. The system has sensors for detecting dynamic conditions of the vehicle and for detecting stutter. An air-supply includes a compressor and at least one storage tank for supplying pressurized air to the tires of the vehicle. An electronic controller processes outputs of the sensor and is connected to valves between the air supply and at least one of the tires for varying pressure in the one tire on detection of stutter.

### FIELD OF THE INVENTION

The present invention relates to a system for controlling the pressure in vehicle tires. More particularly this invention concerns such a system that dynamically responds to road conditions.

### BACKGROUND OF THE INVENTION

A dynamic tire-pressure control system is known having sensors detecting the dynamic conditions of the vehicle, an electronic controller processing output signals of the sensors and connected to compressed-air supply unit and pneumatic valves. The compressed-air supply has at least one compressor and at least one storage tank for compressed air for dynamically increasing and decreasing the tire pressure.

During cornering of a vehicle, centrifugal forces act on the center of gravity of the vehicle and cause a roll acceleration and a roll angle of the vehicular cab. If independent wheel suspensions are provided, the positive load of the tires is increased due to the roll angle of the vehicle body, which leads to a reduction of the contact surface of the tire on the roadway surface. Due to the acting mechanisms of rubber friction between tire and roadway with a non-linear relation between vertical tire force and transferable longitudinal and lateral forces, the potential for the transfer of cornering forces and thus of the maximum cornering speeds that can be realized is reduced. Moreover, roll accelerations generally cause discomfort to the passengers of the vehicle.

Furthermore, periodic stimulations of the vehicle caused by the roadway, for example by concrete roads with a regular distance between joints, may lead to so-called stutter. Stutter is a resonance with a beat frequency resulting from the driving speed and the distance between the joints that is close to the maximum of the resonant frequency of the engine suspension and the chassis and is perceived as a particularly unpleasant sensation by the passengers.

A method for roll stabilization is known from WO 2004/089663 where roll motions of the vehicular cab are detected by sensors and evaluated by an electronic control unit. The electronic unit activates a stabilizer damping the roll motion. Such a principle is generally known as skyhook control.

From WO 2005/063514 a procedure for roll stabilization is known where roll motions of the vehicle vehicular cab are detected by sensors and evaluated by an electronic control unit. The electronic unit controls the damping rate of the adjustable shock absorber and thus damps the roll motion.

Analogous systems are for example described in U.S. Pat. No. 6,179,310, WO 2005/007426 and U.S. 2004/0038599.

U.S. 2006/0043691 describes a pneumatic suspension system for a vehicle where a bellows is provided for each wheel and where the air pressure in the pneumatic spring can be varied for each individual pneumatic spring by means of a respective pneumatic line with a valve.

U.S. Pat. No. 7,076,351 describes a system for dynamic regulation of pneumatic springs where the air pressure in the pneumatic springs varies depending on the driving condition in order to adjust a perfect height for the respective driving condition.

U.S. Pat. No. 6,729,363 describes a pneumatic spring system where an interface is provided for supplying a spare tire with compressed air.

### OBJECTS OF THE INVENTION

It is therefore an object of the present invention to provide an improved dynamic tire-pressure control system.

Another object is the provision of such an improved dynamic tire-pressure control system that overcomes the above-given disadvantages, in particular that increases the comfort and the safety of a vehicle in a comparatively easy way.

### SUMMARY OF THE INVENTION

A dynamic vehicular system for controlling pressure in tires of a vehicle. The system has according to the invention sensors for detecting dynamic conditions of the vehicle and for detecting stutter. An air-supply includes a compressor and at least one storage tank for supplying pressurized air to the tires of the vehicle. An electronic controller processes outputs of the sensor and is connected to valves between the air supply and at least one of the tires for varying pressure in the one tire on detection of stutter.

According to a further feature of the invention, a pneumatic suspension system includes a respective pneumatic spring associated with each of the tires, pneumatic lines connected between the suspension system and the air supply, and a valve in the pneumatic line between the suspension system and at least one of the pneumatic springs. This valve is connected to the electronic controller for varying the pressure in at least one of the pneumatic springs on detection of stutter. The pressures in the one tire and the one spring are varied differently.

Similarly according to the invention a pneumatic engine mount is connected by a pneumatic line with the air supply. A valve in the pneumatic line between the engine mount and the air-supply is connected to the electronic controller for varying the pressure in the engine mount on detection of stutter.

According to the invention a predetermined time after stutter is detected, the electronic control means reestablishes an original pressure condition in the one tire, the engine mount, or the suspension spring, in a predetermined priority order.

### BRIEF DESCRIPTION OF THE DRAWING

The above and other objects, features, and advantages will become more readily apparent from the following description, reference being made to the accompanying drawing in which:

FIG. 1 is a simplified schematic diagram of the system according to the invention; and

FIG. 2 is a block diagram illustrating a vehicle incorporating the system of this invention.

### SPECIFIC DESCRIPTION

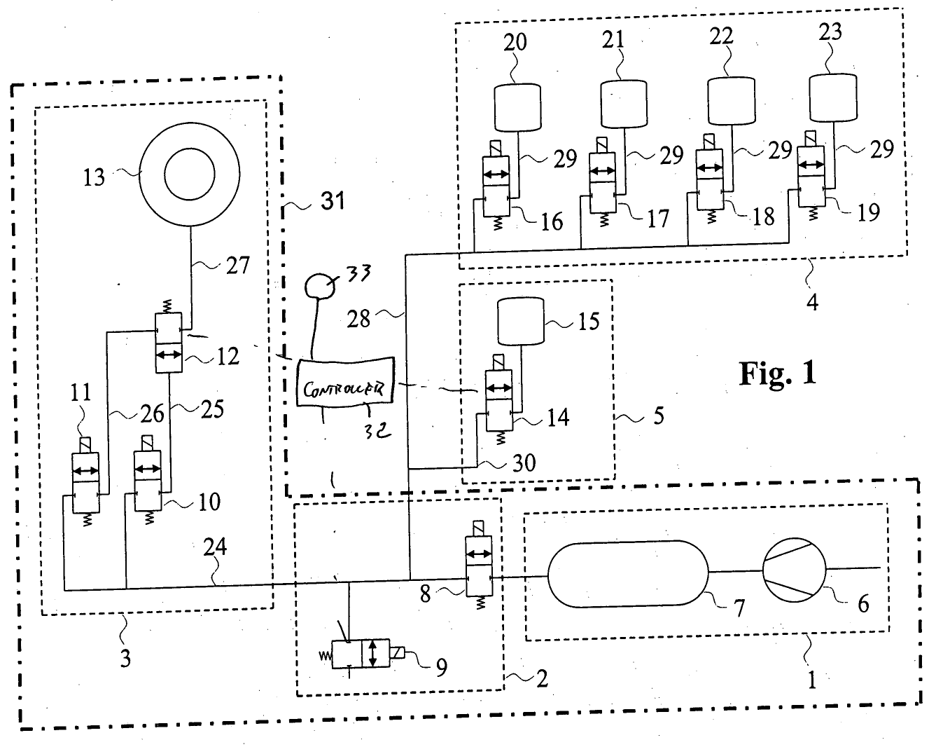

FIG. 1 shows a single wheel unit 3 of a tire-inflation system 31 for one respective wheel 13 only, but in principle the concept can be applied to any number of wheels 13 by adding a respective pneumatically controlled wheel valve 12 to each wheel 13 and it may be applied to the control circuits by adding a respective control valve 10 and a respective filling valve 11 with the necessary pneumatic lines 24, 25, 26, and 27 for each additional controlled wheel 13.

Similarly, a pneumatic suspension system 4 is shown by way of example with four pneumatic spring elements 20, 21, 22, 23, but any other number of pneumatic spring elements can be used as well.

Similarly, a pneumatically adjustable engine-suspension system 5 is shown with a single pneumatically adjustable engine suspension 15, but any other number of pneumatically adjustable engine suspensions can also be used.

Since with the tire pressure control system 31 the working volume of the vehicle wheels 13, which is a multiple of that of one of the pneumatic springs 20, 21, 22 and 23, has to be varied and since moreover, this operation has to be carried out highly dynamically to match vehicle acceleration, the capacity of the tire-pressure control system 31 be much greater than that of the pneumatic spring system 4. Due to this significantly higher capacity of the air supply 1, air can be economically used as working medium for the actuators of the air-conditioning system of the vehicle.

The control actuators of the skyhook control according to the systems described in the state of the art are usually constituted as hydraulic or electromechanical actuators. The design according to the invention of such a control can be realized in a significantly more economic way, since the necessary components are already provided for by the tire pressure control 31 and the pneumatic spring system 4. The air supply unit 1 consists of at least one compressor 6, the performance of which, as far as dynamic control processes are concerned, can be significantly improved by adding at least one air storage tank 7. If several compressed-air storage tanks 7 are used, the storage pressures in the individual storage tanks might be different from each other in order to allow a better operation of the different pressure requirements for the tire-inflation subsystem 3 and the pneumatic spring system 4. The valve block 2 for the air distribution consisting of an inlet valve 8 and a vent valve 9 is required in the same design for the tire-inflation subsystem 3 and the pneumatic spring system 4. The compressed air supply unit 1 of the tire-inflation subsystem 3 is connected to the pneumatic spring system 4 by a pneumatic line 28.

According to the invention, suitable sensors 33, such as those that for example described in WO 2005/063514, measure the roll angle, the vertical vehicular cab acceleration and the roll angle acceleration of the vehicle cab.

If a periodic vertical oscillation, as is typical for stutter, is detected by the sensors and identified as such by a controller 32 connected to the various valves, the air supply unit 1 of the tire pressure control system 31 is activated and the air pressure is varied by a certain amount in all the pneumatic spring elements 20, 21, 22, 23 by opening the pneumatic spring-closed valves 16, 17, 18 and 19 or by opening the vent valve 9 in order to lower pressure or by opening the inlet valve 8 in order to increase pressure. By this pressure variation, the resonant frequency of the wheel suspension and thus the maximum of the resonant frequency of the chassis and of the engine suspension are shifted to a different frequency. Due to the difference between these beat frequencies and the maximum of the resonant frequency, the stutter that affects comfort is significantly reduced.

Due to the fact that the air supply unit 1 of the tire pressure control 31 is connected to the pneumatic spring system 4 by means of the pneumatic connection line 28, the air supply for the pneumatic spring device 4 as shown in FIG. 1 can be omitted, but does not have to be, in order to decrease costs of the system The pressure variation of the pneumatic springs 20, 21, 22 and 23 for influencing the resonant frequency can also be assisted or alternatively effected by a variation of the tire pressure, preferably the pressure being increased in order to avoid a safety-critical driving condition created by excessively low tire pressure. Thus, the inlet valve 8, the control valve 10 and the fill valve 11 are opened, so that compressed air flows to the wheel 13 through the line 26, the pneumatically operated wheel valve 12 opened by the control valve 10, and the line 27.

In one embodiment individual or several pneumatic spring valves 16, 17, 18 and 19 can be opened at same time as the tire-inflating control valves 10 and fill valves 11 so that the pneumatic springs 20, 21, 22 and 23 that are provided with a greater working pressure release air directly into the tires 13 and increase pressure there.

If the vehicle is provided with a pneumatically adjustable engine suspension system 5, air pressure of the pneumatic engine suspensions 15 can be adjusted complementarily or alternatively to one of the solutions described before in a similar manner as the pneumatic spring, in order to adjust the resonant frequency of the engine suspension 15 and thus influence the resonant frequency behavior of the engine suspension/frame assembly such that the maximum of the resonant frequency is even further from the beat frequency. In FIG. 1 the engine suspension system 5 is shown having a pneumatically adjustable support 14 controlled by a respective valve 14 connected to the main supply line 28. In principle an optional number of such mounts 15 can be provided, with respective valves 14. The pneumatic connection to the air supply of the tire-inflation subsystem is through a line 30.

If after this regulation procedure the driving speed of the vehicle changes by a given amount, the set pressure in the tires 13, in the pneumatic springs 20, 21, 22 and 23 and in the engine suspensions 15 is readjusted to the optimal dynamic value. Since the level of working pressure varies strongly for the individual elements, the adjustment of the new set value can also be carried out sequentially according to a priority-ranking system.

Similarly, after a predetermined period of time has elapsed, the original level of air pressure can be readjusted in the individual elements or the original pressure condition can be reestablished in case that other conditions are met that require pressure control of the tires 13 or the pneumatic springs 20, 21, 22 and 23 according to an arbitrary priority ranking system.

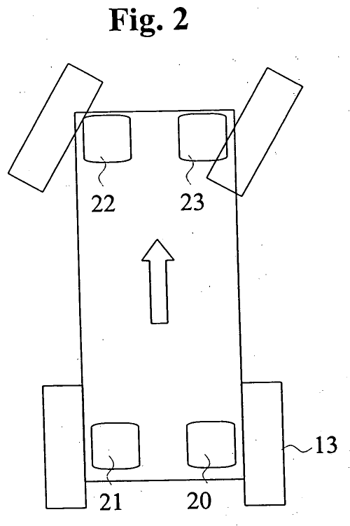

Cornering might be such a priority causing event. If suitable sensors detect a corresponding roll angle acceleration of the vehicular cab, the pressure of the pneumatic springs 21 and 22 according to FIG. 2, which are situated in the outer row when the vehicle is moved through a curve can be increased in order to counteract the vertical forces acting towards the outside. The pressure regulation on the individual pneumatic springs is carried out according to an algorithm depending on the value and the sign of the roll angel acceleration. According to the control algorithm, different pressures, that are perfect for the stabilization of the roll angle, can be set for each pneumatic spring 21 and 21.

In case of reverse counting and/or if one of the limiting values regarding the roll angle acceleration and/or the roll angle determined by the control logics is not achieved, the air pressure is readjusted to the original value in the pneumatic spring elements addressed before for pressure increase according to the algorithm of the control logics, by closing the inlet valve 8 and opening the outlet valve 9. Thereafter, the corresponding pneumatic spring valves 17 and 18 of the pneumatic springs situated in the outer row when the vehicle is moved through a curve are opened until the original pressure level is re-established.

Alternatively to the opening of the outlet valve 9 during the outlet process for setting the original pneumatic spring level, the control valve 10 and the filling valve 11 of the tire-inflation subsystem 3 can be opened in order to use the pressure reduction in the pneumatic spring elements for increasing pressure in the tires 13. This might be a useful combination, for example when the vehicle leaves a curve and is accelerated such that according to the control strategy of the tire-inflation subsystem 3, a higher pressure level should be set and contemporaneously a lower level is determined by the control logic of the pneumatic spring system 4 because of the increased speed.

I claim:

1. A dynamic vehicular system for controlling pressure in tires of a vehicle, the system comprising:
sensors for detecting dynamic conditions of the vehicle and for detecting stutter;
air-supply means including a compressor and at least one storage tank for supplying pressurized air to the tires of the vehicle; and
electronic control means for processing outputs of the sensor and for varying pressure in at least one of the tires on detection of stutter.

2. The tire-pressure control system defined in claim 1 further comprising:
a pneumatic suspension system including a respective pneumatic spring associated with each of the tires;
pneumatic lines connected between the suspension system and the air-supply means; and
valve means in the pneumatic line between the suspension system and at least one of the pneumatic springs and connected to the electronic control means for varying the pressure in at least one of the pneumatic springs on detection of stutter.

3. The tire-pressure control system defined in claim 2 wherein the control means varies the pressures in the one tire and the one spring differently.

4. The tire-pressure control system defined in claim 1, further comprising
a pneumatic engine mount;
a pneumatic line connected between the engine mount and the air-supply means; and
valve means in the pneumatic line between the engine mount and the air-supply means anc connected to the electronic control means for varying the pressure in the engine mount on detection of stutter.

5. The tire-pressure control system defined in claim 1 wherein, a predetermined time after stutter is detected, the electronic control means reestablishes an original pressure condition in the one tire.

6. The tire-pressure control system defined in claim 1 further comprising:
a pneumatic suspension system including a respective pneumatic spring associated with each of the tires;
pneumatic lines connected between the suspension system and the air-supply means;
valve means in the pneumatic line between the suspension system and at least one of the pneumatic springs and connected to the electronic control means for varying the pressure in at least one of the pneumatic springs on detection of stutter;
a pneumatic engine mount;
a pneumatic line connected between the engine mount and the air-supply means; and
valve means in the pneumatic line between the engine mount and the air-supply means anc connected to the electronic control means for varying the pressure in the engine mount on detection of stutter, the electronic control means reestablishing an original pressure in the one tire, engine mount, and pneumatic spring in a predetermined priority order.
